(19) United States
(12) Patent Application Publication
(10) Pub. No.: US 2006/0187573 A1
(43) Pub. Date: Aug. 24, 2006

(54) Sensor equipment guard

(75) Inventor: Bradley Slye, Plymouth, MN (US)

Correspondence Address: Leffert Jay & Polglaze, P.A., P.O. Box 581009, Minneapolis, MN, 55458-1009, US

(73) Assignee: Electro-Sensors, Inc.

(21) Appl. No.: 11/065,203

(22) Filed: Feb. 24, 2005

(51) Int. Cl. G11B 5/596

(52) U.S. Cl. 360/78.13

(57) ABSTRACT

A sensor equipment guard is designed to fit over both the sensing mechanism and the sensor disk/switch while being coupled only to the sensing mechanism. The guard has a back section from which walls extend outward substantially perpendicular from the back and remains open behind the disk/switch. A connection mechanism couples the guard to the sensing mechanism. In one embodiment, the connection mechanism is integral to the guard.

### BACKGROUND

I. Field of the Invention

The present invention relates generally to electrical sensors and more particularly to sensor guards that mount to sensor electronics.

II. Description of the Related Art

Electrical sensors and switches can be used to measure the speed of a conveyor belt, count the number of revolutions of a shaft, and/or determine the speed at which the shaft is rotating. For example, a Hall-effect sensor typically uses a disk, comprised of one or more magnets, that is attached to the shaft and spins at a speed indicative of the speed of a conveyor belt system. The rotating magnetic field or fields generated by the magnet(s) on the disk are detected by sensor electronics that are fixed a short distance from the spinning disk. The magnetic field detection may be indicated by the sensor electronics by generating a pulse upon the detection of each magnetic field. The rate at which the fields are detected indicates the speed of rotation of the sensor disk and, therefore, the attached shaft.

These sensors and switches typically require protection from foreign matter (e.g., dirt, grease) and/or human intervention. For example, the gap between the rotating disk and the sensor electronics allows dirt to collect on the disk from exposure to the environment. Additionally, human intervention can accidentally cause a human appendage or clothing to intercede between the disk and the sensor electronics. In any case, the foreign matter and/or human intervention will probably cause inaccurate readings to result.

One scheme used to cover both the sensor electronics and the sensor disk/switch is to attach a housing to the machine frame in some way that encloses both the sensor disk/switch and the sensor electronics. This typically requires the sensor manufacturer to make different models of housings for different orientations of the sensor and disk/switch or the end user of the sensor equipment has to connect the sensor equipment in only one orientation. This restricts the conveyor system construction to a limited number of orientations.

There is a need in the art for sensor guard that can be adapted for different sensor situations and orientations.

### SUMMARY

The present invention encompasses a sensor disk/switch guard that can be attached to the sensor itself with no attachment to the shaft side or machine frame of the sensor equipment. The guard can then be orientated in multiple ways around the disk/switch.

The guard is comprised of walls that extend from a back section and surround portions of the sensor disk/switch. One side of the guard, opposite to the back section and behind the sensor disk/switch, is open. The guard has means for coupling to the sensing mechanism such that the guard is also not coupled to the sensor disk/switch.

### BRIEF DESCRIPTION OF THE DRAWINGS

FIG. 1 shows a front view of one embodiment of the sensor guard of the present invention.

FIG. 2 shows a side view of one embodiment of the sensor guard in accordance with the embodiment of FIG. 1.

FIG. 3 shows a front view of an alternate orientation of the sensor guard in accordance with the embodiment of FIG. 1.

FIG. 4 shows a front view of another alternate orientation of the sensor guard in accordance with the embodiment of FIG. 1.

FIG. 5 shows a front view of yet another alternate orientation of the sensor guard in accordance with the embodiment of FIG. 1.

FIG. 6 shows an alternate embodiment of the sensor guard of the present invention.

### DETAILED DESCRIPTION

The embodiments of the present invention provide a sensor equipment guard that can be attached to the sensor side of the equipment. This enables the orientation of the guard to be adjustable with respect to the sensor disk/switch thus providing greater flexibility in the installation of the sensor equipment.

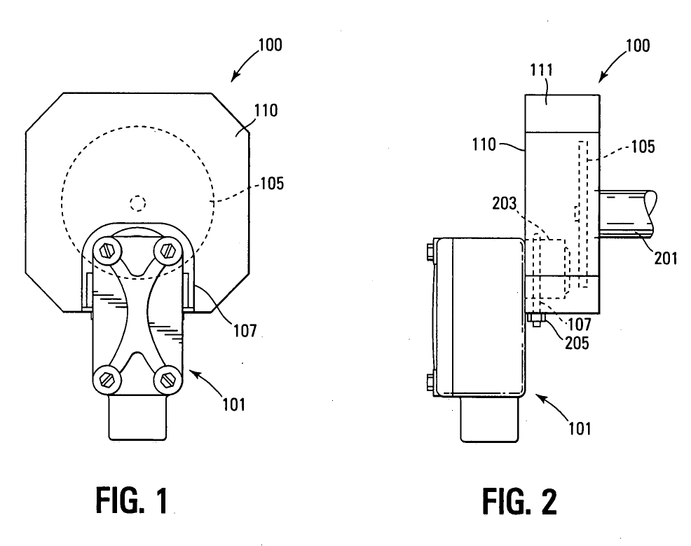

FIGS. 1 and 2 illustrate a front and side view, respectively, of one embodiment for the sensor equipment guard 100 of the present invention. These views show the sensor electronics that are enclosed in a receptacle 101. The sensor electronics can include that part of the sensor equipment that senses the rotation of the disk 105 or, in some configurations, the closing of a switch. The sensor electronics/mechanism can be used to receive any type of signal from the disk/switch including electrical, light, or magnetic signals.

The receptacle 101 can be comprised of an extension 203 to which the guard 100, in one embodiment, can be attached. In this embodiment, the extension 203 is part of and contains the sensing mechanism that is located proximate to the spinning disk 105 that is coupled to the shaft 201. The disk 105 and shaft 201 are for purposes of illustration only. The sensor equipment guard of the present invention can be used to cover any type of sensor switch.

In the embodiments of FIGS. 1 and 2, the guard 100 is connected to the extension 203 with a clamp 107 and nuts 205 as a means for mounting. In one embodiment, the clamp is a U-clamp 107 that encircles a large portion of the extension 203. The threaded ends of the U-clamp 107 protrude through holes in the guard 100. The nuts 205 can then be tightened down onto the guard 100 to hold it securely to the extension.

Alternate embodiments can use other methods for securing the guard 100 to the sensor electronics receptacle 101. The extension 203 and U-clamp 107 are only one means by which this can be accomplished.

The guard 100 itself is comprised of a back section 110 that faces the receptacle 101 and sides 111 that extend outward from the back section 110. The walls 111 can be formed to entirely encircle the sides of the disk/switch 105 or only partially as illustrated in a subsequent embodiment. For ease of installation and removal, the guard, in one embodiment, is open on one side.

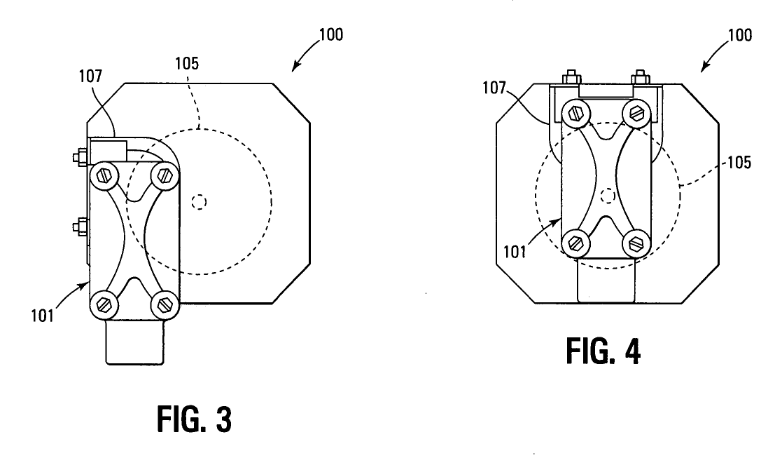

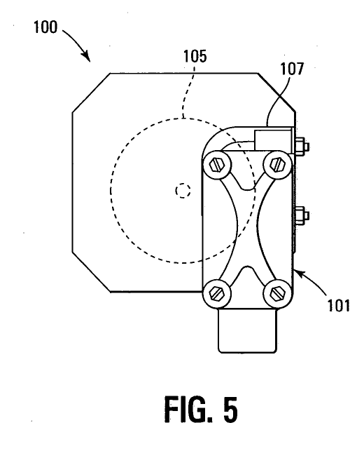

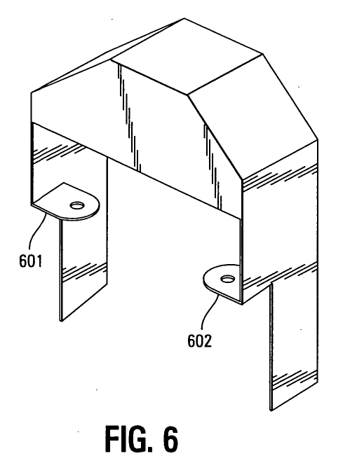

FIGS. 3-5 illustrate variations on the orientation of the sensor equipment guard 100 of the present invention. Since the guard 100 is not coupled to the disk/switch of the sensor equipment, the sensor electronics receptacle can be moved to any desired location with respect to the disk/switch.

FIG. 6 illustrates an alternate embodiment of the sensor equipment guard of the present invention. This embodiment is open at the bottom so that it can slide down over the disk/switch portion of the sensor equipment. In this embodiment, the guard walls extend outward and downward from the half back section such that the lower areas of the sensor disk/switch are still exposed.

The guard can also include integral extensions 601, 602 that can be used instead of the U-clamp to mount the guard to the receptacle. The sensor equipment receptacle can be comprised of threaded extensions over which the holes in the integral extensions 601, 602 can be placed. The embodiments of FIGS. 1-5 can also incorporate the integral extensions as the means for mounting the guard.

While the embodiments of the present invention are illustrated in an octagonal shape, the present invention is not limited to this shape. This shape is generally easier to manufacture from flat material. However, the present invention encompasses alternate embodiments that can be comprised of any other shape including rectangular or circular.

The sensor equipment guard may be manufactured out of any kind of material. In one embodiment, the guard is comprised of stainless steel. However, alternate embodiments can include other types of metal, plastic, fiberglass, paper products, or composites.

Numerous modifications and variations of the present invention are possible in light of the above teachings. It is therefore to be understood that within the scope of the appended claims, the invention may be practiced otherwise than as specifically described herein.

What is claimed is:

1. A sensor equipment guard for covering a sensor disk/switch and a sensing mechanism, the guard comprising:
guard walls that extend from a back section and surround portions of the sensor disk/switch such that one side of the guard, extending around sides of the sensor disk/switch, is open; and
means for mounting the guard to the sensing mechanism wherein the guard is not coupled to the sensor disk/switch.

2. The guard of claim 1 wherein the means for mounting comprises a U-clamp.

3. The guard of claim 1 and further including an extension on the sensing mechanism to which the means for mounting is connected.

4. The guard of claim 1 wherein the means for mounting comprises integral extensions that couple to the sensing mechanism.

5. The guard of claim 4 wherein the integral extensions comprise holes that fit over threaded extensions on the sensing mechanism.

6. The guard of claim 1 wherein the sensor disk/switch is a rotating disk that is coupled to a shaft.

7. The guard of claim 1 wherein the walls extend substantially perpendicular from the back section.

8. A sensor equipment guard for covering a sensor disk/switch and a sensing mechanism, the guard comprising:
a back section that fits over a portion of the sensing mechanism;
guard walls that extend from the back section and surround portions of the sensor disk/switch such that one side of the guard extending behind the sensor disk/switch is open; and
mounting means for coupling the guard to the sensing mechanism such that the guard is not coupled to the sensor disk/switch.

9. The guard of claim 8 wherein the back section comprises an opening that fits around an extension from the sensing mechanism.

10. The guard of claim 8 wherein the back section comprises only an upper portion of the guard and the walls extend outward and downward from the back section wherein the downward extending walls include the mounting means.

11. The guard of claim 10 wherein the mounting means extend inward from the walls.

12. The guard of claim 11 wherein the mounting means extend substantially perpendicular to the walls and each include an opening that fits over threaded extensions coupled to the sensing mechanism.

13. A sensor equipment guard for covering a sensor disk/switch and a sensing mechanism, the guard comprising:
a back section that fits over a portion of the sensing mechanism;
guard walls that extend outward and downward from the back section and surround only upper and side areas of the sensor disk/switch such that one side of the guard extending behind the sensor disk/switch is open; and
integral mounting means for coupling the guard to the sensing mechanism such that the guard is not coupled to the sensor disk/switch.

14. The guard of claim 13 wherein the integral mounting means enables the guard to be coupled to the sensing mechanism in one of a plurality of orientations.

15. The guard of claim 13 wherein the sensing mechanism includes a receptacle comprising an extension to which the guard is coupled.

16. The guard of claim 15 wherein the receptacle includes sensing electronics.

17. The guard of claim 13 wherein the guard is comprised of one of metal, plastic, paper products, composites, or fiberglass.

18. A sensor equipment guard system comprising:
a sensor disk/switch coupled to a shaft that is adapted to rotate;
a sensing mechanism that is positioned proximate to the sensor disk/switch such that signals from the sensor disk/switch are capable of being sensed by the sensing mechanism; and
a sensor equipment guard comprising:
guard walls that extend from a back section and surround portions of the sensor disk/switch such that one side of the guard, extending around sides of the sensor disk/switch, is open; and
means for coupling the guard to the sensing mechanism wherein the guard is not coupled to the sensor disk/switch.

19. The system of claim 18 wherein the signals include one of magnetic, light, or electrical.

20. The system of claim 18 wherein the sensing mechanism indicates a rate of rotation of the shaft.
